(19) United States
(12) Patent Application Publication
(10) Pub. No.: US 2024/0193406 A1
(43) Pub. Date: Jun. 13, 2024

(54) METHOD AND APPARATUS WITH SCHEDULING NEURAL NETWORK

(71) Applicants: SAMSUNG ELECTRONICS CO., LTD., Suwon-si (KR); Seoul National University R&DB Foundation, Seoul (KR)

(72) Inventors: Seok-Young YOON, Suwon-si (KR); Bernhard EGGER, Seoul (KR); Hyemi MIN, Seoul (KR); Jungyoon KWON, Seoul (KR); Jaume Mateu CUADRAT, Seoul (KR)

(73) Assignees: SAMSUNG ELECTRONICS CO., LTD., Suwon-si (KR); Seoul National University R&DB Foundation, Seoul (KR)

(21) Appl. No.: 18/501,135

(22) Filed: Nov. 3, 2023

(30) Foreign Application Priority Data
Nov. 28, 2022 (KR) 10-2022-0161575

(51) Int. Cl. G06N 3/0464

(52) U.S. Cl. CPC G06N 3/0464

(57) ABSTRACT

A method and apparatus with scheduling a neural network (NN), which relate to extracting and scheduling priorities of operation sets, are provided. A scheduler may be configured to receive a loop structure corresponding to a NN model, generate a plurality of operation sets based on the loop structure, generate a priority table for the operation sets based on memory benefits of the operation sets, and schedule the operation sets based on the priority table.

### CROSS-REFERENCE TO RELATED APPLICATIONS

This application claims the benefit under 35 USC § 119(a) of Korean Patent Application No. 10-2022-0161575, filed on Nov. 28, 2022, in the Korean Intellectual Property Office, the entire disclosure of which is incorporated herein by reference for all purposes.

### BACKGROUND

### 1. Field

The following description relates to an apparatus and method with scheduling a neural network (NN).

### 2. Description of Related Art

A typical convolutional neural network (CNN) has been widely used in artificial intelligence (AI) application fields such as image recognition and detection.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented scheduling method may include receiving a loop structure corresponding to a neural network (NN) model; generating operation sets based on the loop structure; generating a priority table for the operation sets based on memory benefits of the operation sets; and scheduling the operation sets based on the priority table.

The generating of operation sets may include generating a first operation list based on the loop structure; performing a first operation scheduling according to the first operation list; updating the first operation list to a second operation list based on the first operation scheduling; and generating operation sets based on the second operation list.

The method may further include performing an operation of the NN model based on a result of the scheduling of the operation sets.

The generating of the priority table may include arranging the operation sets in an ascending order of the memory benefits of the operation sets.

The memory benefits of the operation sets may be determined based on a reusability data size and/or a spilling data size.

The reusability data size may be a data transfer size that is to be reduced by reusing data used in an operation, and the spilling data size may be a data transfer size that increases by avoiding data used in an operation from being reused.

The generating of the priority table may include, in response to a difference in the memory benefits between at least two of the operation sets being less than a first threshold value, arranging the at least two operation sets in an ascending order of memory utilization of the at least two operation sets.

The generating of the priority table may include, in response to a difference in the memory utilization between at least two of the operation sets being equal to or less than a second threshold value, arranging the at least two operation sets in a descending order of memory overhead of the at least two operation sets.

The memory overhead may be a memory state used in an operation for the operation sets; and the memory state may be determined based on a memory loading data size and a memory storing data size.

The loop structure may be one of a plurality of loop structures, which are generated to include different tiling sizes and data flows by receiving a network configuration and a specification of hardware components.

The specification of the hardware components may comprise a number of cores included in the hardware components.

The first operation list may be generated using a directed acrylic graph (DAG) of the loop structure.

In one or more general aspects, a scheduler may include a processor configured to receive a loop structure corresponding to processing operations of a neural network (NN) model; generate operation sets based on the loop structure; generate a priority table for the operation sets based on memory benefits of the operation sets; and schedule the operation sets based on the priority table.

The processor may be configured to generate a first operation list based on the loop structure; perform a first operation scheduling according to the first operation list; update the first operation list to a second operation list based on a result of the first operation scheduling; and generate the operation sets based on the second operation list.

The processor may be configured to arrange the operation sets in an ascending order of the memory benefits of the operation sets.

The memory benefits may be determined based on a reusability data size and/or a spilling data size.

The reusability data size may be a data transfer size that is to be reduced by reusing data used in an operation; and the spilling data size may be a data transfer size that increases by avoiding data used in an operation from being reused.

The processor is configured to, in response to a difference in the memory benefits between at least two of the operation sets being equal to or less than a first threshold value among the operation sets, arrange the at least two operation sets with the difference in the memory benefits equal to or less than the first in an ascending order of memory utilization of the operation sets.

The processor is configured to, in response to a difference in the memory utilization between at least two of the operation sets being equal to or less than a second threshold value among the operation sets, arrange the at least two operation sets with the difference in the memory utilization equal to or less than the second threshold value in a descending order of memory overhead of the operation sets.

In another general aspect, a processor-implemented method may include generating loop structures by receiving a network configuration and a specification of related hardware components; corresponding the generated loop structures to a neural network (NN) model; generating scheduled operation lists for the loop structures, respectively, based on predetermined priorities of operating the NN model; and determining a final scheduled operation list among the generated scheduled operations lists, wherein the final scheduled operation list has a smallest latency and data transfer size among the scheduled operation lists.

Other features and aspects will be apparent from the following detailed description, the drawings, and the claims.

### BRIEF DESCRIPTION OF THE DRAWINGS

FIG. 1 illustrates an example operation of a data computation apparatus according to one or more embodiments.

FIG. 2 illustrates an example scheduling method according to one or more embodiments.

FIG. 3 illustrates an example method of generating operation sets according to one or more embodiments.

FIG. 4A and 4B illustrate an example method of generating operation sets according to one or more embodiments.

FIG. 5 illustrates an example method of calculating a memory benefit and memory overhead according to one or more embodiments.

Throughout the drawings and the detailed description, unless otherwise described or provided, the same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Hereinafter, examples will be described in detail with reference to the accompanying drawings. When describing the examples with reference to the accompanying drawings, like reference numerals refer to like components and a repeated description related thereto will be omitted.

Various CNN accelerators are being used to process the CNN operations. With the development of CNNs, the network size, the number of times of performing an operation and the memory usage have been rapidly increasing to improve CNN accuracy and execution speed. As a CNN may have an extensive network size and frequent data transfer such as data loading and storing, a CNN accelerator typically has a long processing time or an increased latency due to lowered utilization of hardware, regardless of reduced data transfer. Therefore, there is a need to develop new technology to efficiently allocate CNN operations to computing resources to optimize CNN operations, in particular, CNN accelerators having limited computing resources.

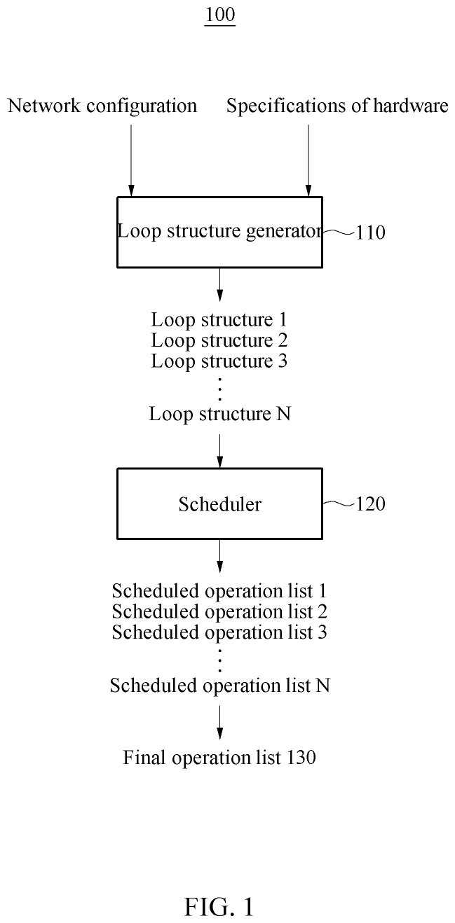

FIG. 1 illustrates an example operation of a data computation apparatus according to one or more embodiments.

One or more blocks or a combination thereof shown in FIG. 1 may be embodied by a special purpose hardware-based computer that performs a predetermined function, or a combination of special purpose hardware and computer instructions.

In one embodiment, a data computation apparatus 100 may include a loop structure generator 110 and a scheduler 120 as an agent. The loop structure generator 110 and the scheduler 120 may be each configured as a processor-implemented element or a computer-implemented element.

The data computation apparatus 100 may include a processor (shorthand for any calculator of one or more processors). The processor may control the overall operation of the data computation apparatus 100. As non-limiting examples, the processor may be implemented as an array of logic gates or as a combination of a general-purpose microprocessor and a memory in which a program to be executed in the general-purpose microprocessor is stored, and the memory may include a non-transitory computer-readable medium (for example, a high-speed random access memory) and/or a non-volatile computer-readable medium (for example, at least one disk storage device, flash memory device, or another non-volatile solid-state memory device). In addition, the processor may be implemented in another type of hardware component(s).

The loop structure generator 110 may generate loop structures (e.g., a loop structure 1, a loop structure 2, a loop structure 3, . . . , a loop structure N) by receiving a network configuration and specifications of related hardware components. The generated loop structures may correspond to an artificial neural network (ANN) model.

The loop structure generator 110 may receive the network configuration and specifications of hardware components and generate the loop structures such that the loop structures may include different tiling sizes and different data flows (e.g., a loop order), respectively. Each of the loop structures may include a structure to perform a convolution operation. The specifications of the hardware components may include a number of cores included in the hardware components.

In one example, the loop structures generated in the hardware components with two cores may be represented as in Equations 1 and 2 below:

Equation 1

| for ow=0 to OW, ow+=3 do | | | | : Loop1 | Tiling size |
|---|---|---|---|---|---|
| \| | for oh=0 to OH, oh+=3 do | | | : Loop2 | ow = 3, oh = 3, ic = 32, oc = 32 |
| \| | \| | for ic=0 to IC, ic+=64 do | | : Loop3 | Loop order |
| \| | \| | \| | for oc=0 to OC, oc+=32 do | : Loop4 | Loop1-Loop2-Loop3-Loop4 |

| \| | \| | \| | \| |
|---|---|---|---|
| tCONV N₂ | | | OT[ow:ow+3][oh:oh+3][oc:oc+32] |
| \| | \| | \| | += IN[ic [symbol] ic+32][iw:iw+3][ih:ih+tih] * WT[oc:oc+32][ic:ic+32] |
| \| | \| | \| | |
| tCONV N+1: | | | OT[ow:ow+3][oh:oh+3][oc:oc+32] |
| \| | \| | \| | += IN[ic+32:ic+64][iw:iw+3][ih:ih+3] * WT[oc:oc+32]][ic+32:ic+64] |
| \| | \| | \| | \| |
| \| | \| | \| | end |
| \| | \| | end | |
| \| | end | | |
| end | | | |

[symbol]

indicates data missing or illegible when filed

Equation 2

| for ow=0 to OW, ow+=6 do | | | | : Loop1 | Tiling size |
|---|---|---|---|---|---|
| \| | for ic=0 to IC, ic+=128 do | | | : Loop3 | ow = 6, oh = 6, ic = 128, oc = 32 |
| \| | \| | for oc=0 to OC, oc+=64 do | | : Loop4 | Loop order |
| \| | \| | \| | for oh=0 to OH, oh+=6 do | : Loop2 | Loop1-Loop3-Loop4-Loop |

| | | | |
|---|---|---|---|
| \| | \| | \| | \| |

tCONV N₅ OT[ow:ow+6][oh:oh+6][oc:oc+32]

| | | | |
|---|---|---|---|
| \| | \| | \| | \| += IN[ic:ic+128][iw:iw+6][ih:ih+6] * WT[oc:oc+32][ic:ic+128] |
| \| | \| | \| | \| |

tCONV N+I: OT[ow:ow+6][oh:oh+6][oc+32:oc+64]

| | | | |
|---|---|---|---|
| \| | \| | \| | \| += IN[ic:ic+128][iw:iw+6][ih:ih+6] * WT[oc+32:oc+64]][ic:ic+128] |
| \| | \| | \| | \| |
| \| | \| | \| | end |

| | | |
|---|---|---|
| \| | \| | end |

| | |
|---|---|
| \| | end |

end

The scheduler 120 may receive the loop structures and generate a corresponding scheduled operation list (one of scheduled operation lists 1, 2, 3, . . . , N in FIG. 1) for a corresponding one of the loop structures 1, 2, 3, . . . N. The scheduler may be configured to determine a final scheduled operation list 130, which may have a smallest latency and data transfer size among the scheduled operation lists 1, 2, 3, . . . , N in FIG. 1.

In one example, the scheduler 120 may perform priority scheduling on the operation lists 1, 2, 3, . . . , N for the respective loop structures 1, 2, 3, . . . , N. The scheduler 120 may find an optimized order in which operations are to be performed through an optimized scheduling, which is the final operation list 130 generated from the scheduled operation lists.

In a multi-core neural process unit (NPU), a memory may be expected to store a larger quantity of data as the multi-core NPU simultaneously performs operations. When data sharing among multiple cores is performed, reusability of data in the memory may be possible.

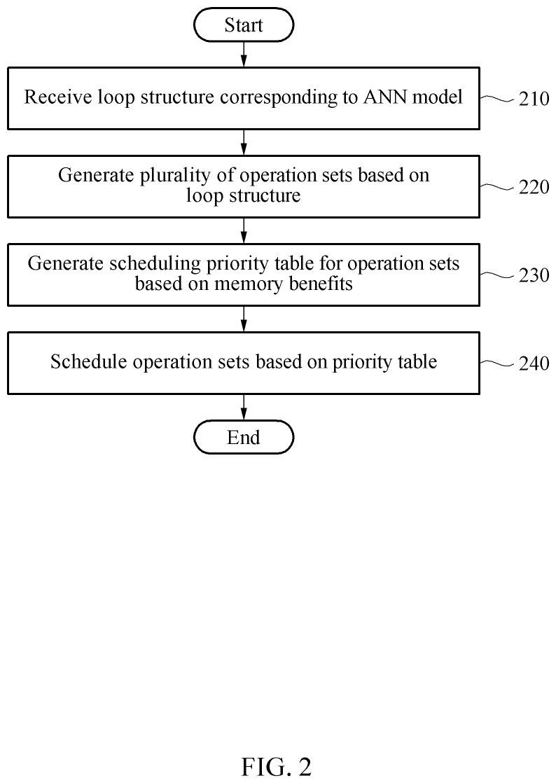

Patterns of data sharing may vary depending on the order of performing operations. If operations are sequentially performed, reusability of data in the memory may be limited. An operation of the scheduler 120 is described with reference to FIGS. 2 through 5.

The data computation apparatus 100 may perform an operation of the ANN model based on the final operation list 130, which is a result of scheduling performed by the scheduler 120.

FIG. 2 illustrates an example scheduling method according to one or more embodiments.

In one embodiment, the scheduling method may include operations 210 through 240 as shown in FIG. 2. Operations 210 through 240 may be performed in the order and method illustrated, but at least one of the operations 210 through 240 may be modified or omitted without departing from the scope of the present disclosure. Operations 210 through 240 of FIG. 2 may be performed in parallel, simultaneously, or any other sequence/order that is suitable to the scheduling method.

For convenience of description, operations 210 through 240 may be performed by the scheduler 120 illustrated in FIG. 1. However, operations 210 through 240 may be performed by other proper processor-implemented electronic devices and in other proper processor-implemented systems.

In operation 210, the scheduler 120 may receive a loop structure (e.g., one of loop structures 1, 2, 3, . . . , and N) corresponding to an ANN model.

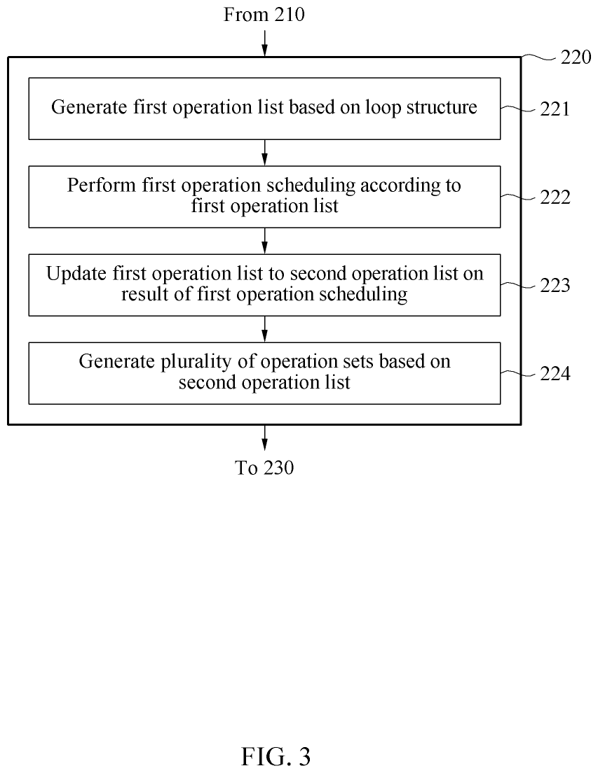

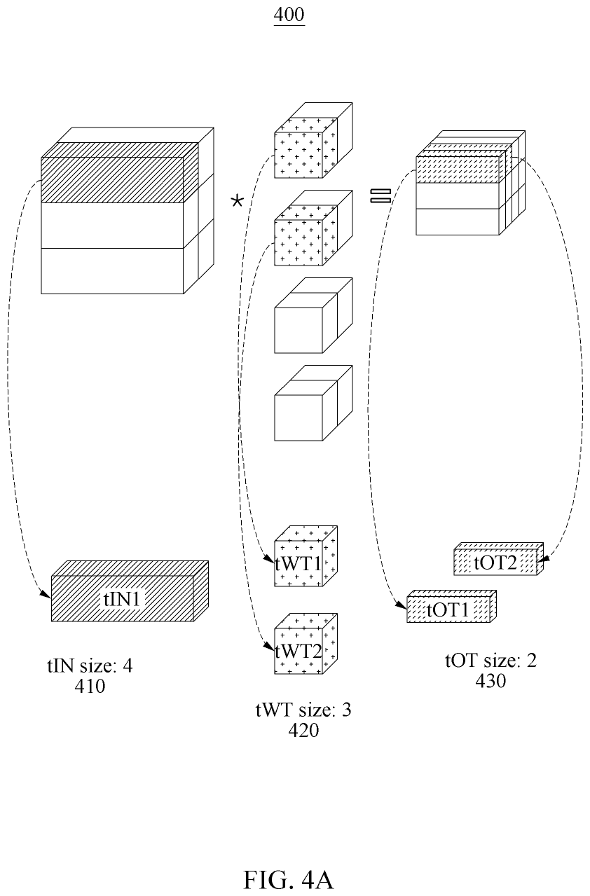

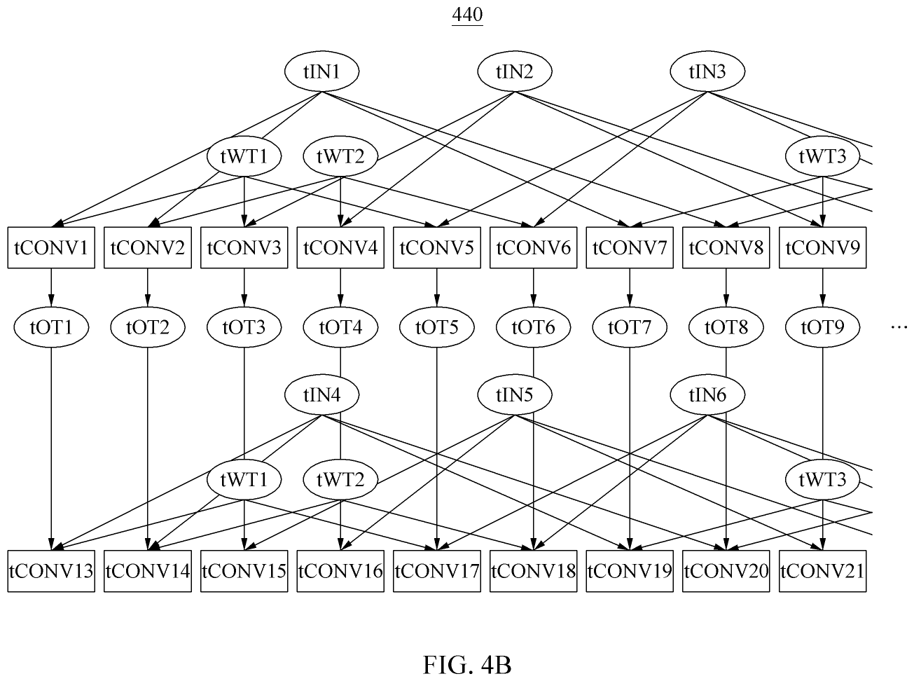

In operation 220, the scheduler 120 may generate operation sets based on the received loop structure. An operation of generating operation sets is described with reference to FIGS. 3 to 4B.

In operation 230, the scheduler 120 may generate a priority table for the operation sets based on determined memory benefits of the operation sets.

The scheduler 120 may arrange the operation sets in an ascending order of their respective memory benefits. The memory benefits may be determined based on a reusability data size and/or a spilling data size. For example, the memory benefits of a given operation set may indicate a data size determined to be potentially obtained by subtracting a spilling data size from a reusability data size.

The reusability data size may be a data transfer size that is to be reduced by reusing data used in an operation. The spilling data size may be a data transfer size that increases by preventing/avoiding data used in an operation from being reused.

When a difference in the memory benefits among some of the operation sets is equal to or less than a first threshold value, the scheduler 120 may arrange those operation sets in an ascending order of memory utilization of the operation sets.

In one example, when the first threshold value is “0.5” and a difference in the memory benefits between at least two operation sets, for example, operation sets 1 and 2, is “0”, the scheduler 120 may prioritize the operation set having a higher memory utilization (between the operation sets 1 and 2).

When a difference in the memory utilization between some operation sets is equal to or less than a second threshold value, the scheduler 120 may arrange those operation sets in a descending order of their memory overhead.

The memory overhead may be a memory state used in an operation of the operation sets. The memory state may be determined based on a memory loading data size and a memory storing data size of the operation. For example, the memory state may be determined by a data size obtained by adding the memory loading data size and the memory storing data size.

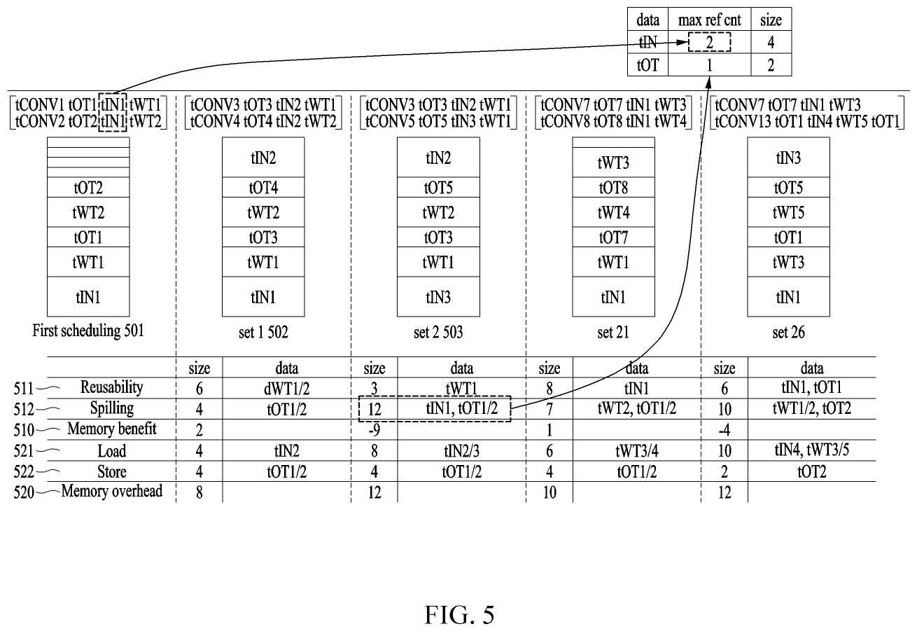

In one example, when the second threshold value is “0.01” and a difference in the memory utilization between at least two operation sets, for example, an operation set 1 and an operation set 2, is “0”, the scheduler 120 may prioritize the operation set with lower memory overhead (between the operation sets 1 and 2). An example of generating a priority table for such prioritizing is described in detail with reference to FIG. 5.

In operation 240, the scheduler 120 may schedule the operation sets based on the priority table.

FIG. 3 illustrates an example method of generating operation sets according to one or more embodiments.

In one embodiment, the method may include operations 221 through 224 as shown in FIG. 3.

Operations 221 through 224 of FIG. 3 may be performed in the order and method illustrated, but at least one of the operations 221 through 224 may be modified or omitted without departing from the scope of the present disclosure. Operations 221 through 224 of FIG. 3 may be performed in parallel, simultaneously, or any predetermined sequence/order that is suitable to generate the operation sets.

Referring to FIG. 3, operations 221 through 224 may be performed by the scheduler 120 described with reference to FIGS. 1 and 2, and a repeated description thereof is omitted herein.

In operation 221, the scheduler 120 may generate a first operation list, which is one of the scheduled operation lists 1, 2, 3, . . . N in FIG. 1, based on a corresponding loop structure, which is one of the loop structures 1, 2, 3, . . . N in FIG. 1. The scheduler 120 may generate the first operation list using a directed acyclic graph (DAG) of the corresponding loop structure. A process of generating the first operation list is described with reference to FIGS. 4A and 4B.

In operation 222, the scheduler 120 may perform a first operation scheduling according to the first operation list (also shown by Table 1 below). If a scheduled priority table is absent, the scheduler 120 may schedule operations in an order that the operations are generated. The scheduling performed in the first operation scheduling (hereinafter, referred to as “first scheduling”) is described with reference to FIG. 5.

In operation 223, the scheduler 120 may update the first operation list to a second operation list based on a result of the first scheduling. In one example, the updating may be performed based on the DAG of the corresponding loop structure. After the scheduler 120 updates the first operation list to the new second operation list (also shown by Table 2 below), a priority table is updated according to the memory benefits, memory utilization, and memory overhead in the second operation list.

In operation 224, the scheduler 120 may generate operation sets based on the second operation list. The scheduler 120 may select an operation with a highest priority, based on a priority table that is generated based on the memory benefits, memory utilization, and memory overhead in the second operation list, and may perform scheduling to generate the final operation list 130 in FIG. 1.

FIGS. 4A and 4B illustrate an example method of generating operation sets according to one or more embodiments.

One or more blocks or a combination thereof shown in FIGS. 4A and 4B may be embodied by a special purpose hardware-based computer that performs a predetermined function, or a combination of special purpose hardware and computer instructions.

The description provided with reference to FIGS. 1 to 3 may be applied to FIGS. 4A and 4B.

In one embodiment, referring to FIG. 4A, a convolution system 400 may include tOT 430 which is a result of a convolution operation of tIN 410 and tWT 420 (“IN” refers to input data, “WT” refers to weight data, “OT” refers to result data, and “t” refers to tile/tiling). In the convolution system 400, a data size of tIN 410 may be set to “4”, and a data size of tWT 420 to “3”. Based on the set data size of tIN 410 and tWT 420, a data size of tOT may be set to “2”.

Referring to FIG. 4B, one example of a convolution operation process of an ANN model (on which tiling has been performed in the convolution system 400) may be illustrated using a DAG 440.

If all operations that may be performed in the convolution system 400 are combined, operation sets including operations to be performed in parallel may be generated. Based on the DAG 440, a convolution operation (e.g., tCONV in FIG. 4B) may be performed by combining tIN 410 and tWT 420 of an ANN model on which tiling has been performed. Example operations shown using the DAG 440 are shown in Table 1 below. Operations in Table 1 may be referred to as a “ready operation list” (e.g., the first operation list of FIG. 3).

TABLE 1
Convolution system

| Operations | Output | Input | Weight |
|---|---|---|---|
| tCONV1 | tOT1 | tIN1 | tWT1 |
| tCONV2 | tOT2 | tIN1 | tWT2 |
| tCONV3 | tOT3 | tIN2 | tWT1 |
| tCONV4 | tOT4 | tIN2 | tWT2 |
| tCONV5 | tOT5 | tIN3 | tWT1 |
| tCONV6 | tOT6 | tIN3 | tWT2 |
| tCONV7 | tOT7 | tIN1 | tWT3 |
| tCONV8 | tOT8 | tIN1 | tWT4 |
| tCONV9 | tOT9 | tIN2 | tWT3 |
| tCONV10 | tOT10 | tIN2 | tWT4 |
| . . . | . . . | . . . | . . . |
| tCONV13 | tOT13 | tIN4 | tWT5 |
| tCONV14 | tOT14 | tIN4 | tWT6 |
| . . . | . . . | . . . | . . . |

In 2-core hardware, an example of operations that may be combined after tCONV1 and tCONV2 have been performed is shown in Table 2. The operations in Table 2 may be a newly updated ready operation list (e.g., the second operation list of FIG. 3). A method of generating a priority table after the first scheduling is performed is described with reference to FIG. 5.

TABLE 2

| Set ID | Operation |
|---|---|
| Set1 | {tCONV3, tCONV4} |
| Set2 | {tCONV3, tCONV5} |
| Set3 | {tCONV3, tCONV6} |
| . . . | |
| Set21 | {tCONV7, tCONV8} |
| Set22 | {tCONV7, tCONV9} |
| . . . | |
| Set26 | {tCONV7, tCONV13} |

FIG. 5 illustrates an example process of calculating memory benefits and memory overhead according to one or more embodiments.

The description provided with reference to FIGS. 1 through 4B may be applied to FIG. 5.

In one embodiment, referring to FIG. 5, the scheduler 120 may perform the first scheduling, generate a second operation list, and generate a priority table based on the second operation list. A memory benefit 510 may be determined based on a memory transfer size that is determined to be required for an operation of an operation set (e.g., one of operation sets in Table 2) in a result of the first scheduling 501.

Memory overhead 520 may be determined based on a memory storing state that is required for an operation of an operation set (e.g., one of the operation sets in Table 2) in the result of the first scheduling 501.

The memory benefit 510 may be determined by a value obtained by subtracting a spilling data size 512 from a reusability data size 511.

Memory overhead 520 may be determined by a value obtained by adding a memory loading data size 521 that is required for memory loading to a memory storing data size 522 that is required for memory storing.

After the first scheduling 501 is performed, the scheduler 120 may calculate the memory benefits and memory overhead of each of the operation sets based on the second operation list (e.g., Table 2).

In one example, a memory benefit 510 of a set 1 502 may be determined by a value obtained by subtracting a size of spilling data tOT1 and tOT2 from a size of reusability data tWT1 and tWT2. Since a data size of tWT is “3”, the reusability data size 511 of the set 1 502 may be “6”. Since a data size of tOT is “2,” the spilling data size 512 of the set 1 502 may be “4.” The memory benefit 510 of the set 1 502 is thus determined to be “2,” which is a value obtained by subtracting “4” from “6.” Memory overhead 520 of the set 1 502 may be determined by a size obtained by adding loading data tIN2 and storing data tOT1 and tOT2. Since a data size of tIN is “4” and a data size of tOT is “2,” a loading data size of the set 1 502 is “4” and a storing data size of the set 1 502 is “4.” The memory overhead 520 of the set 1 502 is thus determined to be “8,” which is a value obtained by adding the loading data size “4” and the storing data size “4.”

A memory benefit 510 of a set 2 503 may be determined by a value obtained by subtracting a size of spilling data tIN1, tOT1, and tOT2 from a size of reusability data WT1. Since a data size of (WT is “3,” the reusability data size 511 of the set 2 503 may be “3.” Since a data size of tIN is “4” and a data size of tOT is “2,” the spilling data size 512 of the set 2 503 may be “12.” The memory benefit 510 of the set 2 503 is thus determined to be “−9,” which is a value obtained by subtracting “12” from “3.” Memory overhead 520 of the set 2 503 may be determined by a size obtained by adding loading data tIN2 and tIN3 and storing data tOT1 and tOT2. Since a data size of tIN is “4” and a data size of tOT is “2,” a loading data size of the set 2 503 is “8” and a storing data size of the set 2 503 is “4.” The memory overhead 520 of the set 2 503 is thus determined to be “12,” which is a value obtained by adding the loading data size “8” and the storing data size “4”.

Table 3 shows a result of performing the calculation on all operation sets.

TABLE 3

| Set | | Memory | Memory | | |
|---|---|---|---|---|---|
| ID | Operation | Benefit | Overhead | Utility | Priority |
| Set1 | tCONV3/4 | 2 | 8 | 1 | 1 |
| Set2 | tCONV3/5 | −9 | 12 | 1 | 7 |
| Set3 | tCONV3/7 | −6 | 12 | 1 | 6 |
| Set4 | tCONV3/6 | 0 | 11 | 1 | 3 |
| Set5 | tCONV3/8 | −3 | 7 | 1 | |
| . . . | | | | | |
| Set21 | tCONV7/8 | 1 | 10 | 0.94 | 2 |
| Set22 | tCONV7/9 | −3 | 11 | 1 | 4 |
| . . . | | | | | |
| Set26 | tCONV7/13 | −4 | 12 | 1 | 5 |

In one example, referring to Table 3, since the memory benefit 510 of the Set 1 502 performing an operation {tCONV3, tCONV4} is “2”, which is a highest value, the Set 1 502 may have a highest priority. The scheduler 120 may generate memory operations required for an operation of the set 1 502 and perform scheduling. For example, if tIN2 is not loaded on a memory, the scheduler 120 may generate an operation that loads tIN2 (Load tIN2 operation) and perform scheduling before performing operations tCONV3 and tCONV4.

The scheduler 120 may store scheduled operations in a scheduled operation list. Table 4 is an example of a scheduled operation list as the final operation list 130 in FIG. 1.

TABLE 4

| | |
|---|---|
| LOAD | tIN1 |
| LOAD | tWT1 |
| LOAD | tWT2 |
| tCONV1 | tOT1 tIN1 tWT1 |
| tCONV2 | tOT2 tIN1 tWT2 |
| LOAD | tIN2 |
| tCONV3 | tOT3 tIN2 tWT1 |
| tCONV4 | tOT4 tIN2 tWT2 |
| . . . | . . . |

The scheduler 120 may generate a scheduled operation list (e.g., a scheduled operation list 1, 2, 3, . . . , N in FIG. 1) for each loop structure and may determine a scheduled operation list with a smallest latency and a data transfer size from scheduled operation lists as a final operation list 130.

The loop structure generator 110, the scheduler 120, and other software and computer-implemented elements described herein and disclosed herein described with respect to FIGS. 1-5 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A processor-implemented scheduling method, comprising:
receiving a loop structure corresponding to a neural network (NN) model;
generating operation sets based on the loop structure;
generating a priority table for the operation sets based on memory benefits of the operation sets; and
scheduling the operation sets based on the priority table.

2. The method of claim 1, wherein the generating of operation sets comprises:
generating a first operation list based on the loop structure;
performing a first operation scheduling according to the first operation list;
updating the first operation list to a second operation list based on the first operation scheduling; and
generating operation sets based on the second operation list.

3. The method of claim 1, further comprising:
performing an operation of the NN model based on a result of the scheduling of the operation sets.

4. The method of claim 1, wherein the generating of the priority table comprises arranging the operation sets in an ascending order of the memory benefits of the operation sets.

5. The method of claim 1, wherein the memory benefits of the operation sets are determined based on a reusability data size and/or a spilling data size.

6. The method of claim 5, wherein
the reusability data size is a data transfer size that is to be reduced by reusing data used in an operation, and
the spilling data size is a data transfer size that increases by avoiding data used in an operation from being reused.

7. The method of claim 1, wherein the generating of the priority table comprises, in response to a difference in the memory benefits between at least two of the operation sets being less than a first threshold value, arranging the at least two operation sets in an ascending order of memory utilization of the at least two operation sets.

8. The method of claim 7, wherein the generating of the priority table comprises, in response to a difference in the memory utilization between at least two of the operation sets being equal to or less than a second threshold value, arranging the at least two operation sets in a descending order of memory overhead of the at least two operation sets.

9. The method of claim 8, wherein
the memory overhead is a memory state used in an operation for the operation sets; and
the memory state is determined based on a memory loading data size and a memory storing data size.

10. The method of claim 1, wherein the loop structure is one of a plurality of loop structures, which are generated to include different tiling sizes and data flows by receiving a network configuration and a specification of hardware components.

11. The method of claim 10, wherein the specification of the hardware components comprise a number of cores included in the hardware components.

12. The method of claim 2, wherein the first operation list is generated using a directed acrylic graph (DAG) of the loop structure.

13. A scheduler, comprising:
a processor configured to:
receive a loop structure corresponding to processing operations of a neural network (NN) model;
generate operation sets based on the loop structure;
generate a priority table for the operation sets based on memory benefits of the operation sets; and
schedule the operation sets based on the priority table.

14. The scheduler of claim 13, wherein the processor is configured to:
generate a first operation list based on the loop structure;
perform a first operation scheduling according to the first operation list;
update the first operation list to a second operation list based on a result of the first operation scheduling; and
generate the operation sets based on the second operation list.

15. The scheduler of claim 13, wherein the processor is configured to arrange the operation sets in an ascending order of the memory benefits of the operation sets.

16. The scheduler of claim 13, wherein the memory benefits are determined based on a reusability data size and/or a spilling data size.

17. The scheduler of claim 16, wherein
the reusability data size is a data transfer size that is to be reduced by reusing data used in an operation; and
the spilling data size is a data transfer size that increases by avoiding data used in an operation from being reused.

18. The scheduler of claim 13, wherein the processor is configured to, in response to a difference in the memory benefits between at least two of the operation sets being equal to or less than a first threshold value among the operation sets, arrange the at least two operation sets with the difference in the memory benefits equal to or less than the first in an ascending order of memory utilization of the operation sets.

19. The scheduler of claim 18, wherein the processor is configured to, in response to a difference in the memory utilization between at least two of the operation sets being equal to or less than a second threshold value among the operation sets, arrange the at least two operation sets with the difference in the memory utilization equal to or less than the second threshold value in a descending order of memory overhead of the operation sets.

20. A processor-implemented method, comprising:
generating loop structures by receiving a network configuration and a specification of related hardware components;
corresponding the generated loop structures to a neural network (NN) model;
generating scheduled operation lists for the loop structures, respectively, based on predetermined priorities of operating the NN model; and
determining a final scheduled operation list among the generated scheduled operations lists,
wherein the final scheduled operation list has a smallest latency and data transfer size among the scheduled operation lists.
